(19) United States
(12) Patent Application Publication
(10) Pub. No.: US 2026/0060867 A1
(43) Pub. Date: Mar. 5, 2026

(54) Fixing pathologicoanatomic headrest with a rubber pad with a sulfur mass content of 4 percent

(71) Applicant: Alexey Fedorovich Khoroshev, Moscow (RU)

(72) Inventor: Alexey Fedorovich Khoroshev, Moscow (RU)

(21) Appl. No.: 18/962,177

(22) Filed: Nov. 27, 2024

(30) Foreign Application Priority Data
Sep. 5, 2024 (RU) 2024126179

(51) Int. Cl. A61G 13/12

(52) U.S. Cl. CPC A61G 13/121; A61G 13/126; A61G 13/1285; A61G 2210/00

(57) ABSTRACT

The invention relates to the field of pathological anatomy. A fixing pathologicoanatomic headrest with a rubber pad with a sulfur mass content of 4 percent, consisting of a pathological anatomical headrest having one stop for one side of the head, fixed to the surface of the headrest, on which the head of a corpse is located during a pathological anatomical autopsy, and a second stop with the ability to move and fix relative to the surface of the headrest until it stops at the other side of the head so that this side part of the head, also resting against the fixed above-mentioned stop and located on the surface of the headrest, also rests against the above-mentioned second stop with a force sufficient to fix the head located on the headrest, between the above-mentioned stops in the above-mentioned position, characterized by the presence of a rubber plate with a sulfur mass content of 4 percent, covering the surface of the above stop, fixed to the surface of the headrest and facing the above-mentioned stop, having the ability to move, mounted on this surface. The technical result is a prevention of slippage of the side part of the head pressed against this plate corresponding to the efficiency of the elasticity of the above-mentioned rubber plate with a mass content of sulfur of 4 percent. One independent claim. One illustration.

### TECHNICAL FIELD TO WHICH THE INVENTION RELATES

The field of application of the claimed invention is pathological anatomy. The claimed invention (hereinafter also referred to as “invention”) relates to technical solutions for pathological anatomy, i.e. to such technical field as devices for autopsy of corpses.

### TECHNICAL LEVEL

Various pathologicoanatomic headrests are well known. In this case, the only and closest analogue (prototype) to the claimed invention is the Fixing pathologicoanatomic headrest known from the patent of the Russian Federation No. 2816697 (bibliographic data of the information source in which it is disclosed: https://fips. ru/EGD/23365ed1-c0ba-49dc-be87-a6c8eb57b96f), which has the following features that coincide with the essential features of the invention: Fixing pathologicoanatomic headrest, consisting of a pathologicoanatomic headrest, having one stop for one side of the head, fixed to the surface of the headrest, on which the head of the corpse is located during the pathologicoanatomic autopsy, and a second stop with the ability to move and fix relative to the surface of the headrest until it stops at the other side of the head so that this side part of the head, also resting against the above-fixed stop and located on the surface of the headrest, also rests against the above-mentioned second stop with a force sufficient to fix the head located on the headrest between the above-mentioned stops in the above-mentioned position. In this case, the technical problem, the solution of which is ensured by the implementation of the invention and which could not be solved by the implementation of invention analogues, is the optimization of the fixation of the head of a corpse by a fixing pathologicoanatomic headrest with the presence of a rubber plate with a sulfur mass content of 4 percent, covering the surface of the above-mentioned stop fixed on the surface of the headrest, mounted on this surface, facing the above-mentioned stop, having the ability to move. Whereas, when implementing the above-mentioned analogue (prototype), the above-mentioned fixation of the head of the corpse occurs as a result of pressing the corresponding above-mentioned lateral part of the head to the above-mentioned stop, on which, during this pressing, when implementing the above-mentioned analogue (prototype), no certain impediment to the displacement of the fixed head of the corpse corresponding to the shape of the pressed lateral part of the head of the corpse arises, characteristic specifically for the elasticity of the rubber plate with a sulfur mass content of 4 percent, caused by pressing the head of the corpse of the depression on the surface of the stop due to the absence, when implementing the analogue (prototype), of a rubber plate with a sulfur mass content of 4 percent, having an elasticity corresponding specifically to this parameter, covering the surface of the above-mentioned stop facing the above-mentioned stop, having the ability to move, fixed to the surface of the headrest, installed on this surface. Whereas, when implementing the invention, an objective technical result is obtained, consisting in preventing the slippage of the lateral part of the head pressed against this plate, corresponding in efficiency to the elasticity of the above-mentioned rubber plate with a mass content of sulfur of 4 percent, which is a consequence of the technical effect objectively manifested when using the invention, associated with such a property as the elasticity of the above-mentioned rubber plate with a mass content of sulfur of 4 percent, preventing the displacement of the fixed head of the corpse corresponding to the shape of the pressed lateral part of the head of the corpse of a certain, characteristic precisely for the elasticity of the above-mentioned rubber plate with a mass content of sulfur of 4 percent, caused by pressing the head of the corpse of a depression in the surface of the above-mentioned plate with a mass content of sulfur of 4 percent due to, as a consequence, the presence during the implementation of the invention of this rubber plate with a mass content of sulfur of 4 percent, having an elasticity corresponding precisely to this parameter, covering the surface of the above-mentioned, fixed, facing the above-mentioned stop, having the ability to move on the surface of the headrest stop, installed on this surface. The stated goal is achieved by the device (design) of the Fixing pathologicoanatomic headrest with a rubber pad with a sulfur mass content of 4 percent, which is a product of hinventionan activity, the elements of which are in a constructive unity and functional relationship corresponding to the concept of a device, as an object claimed as an invention.

### DISCLOSURE OF THE ESSENCE OF THE INVENTION

The essence of the invention, as a technical solution, is expressed in the following set of essential features:

1. A fixing pathologicoanatomic headrest with a rubber pad with a sulfur mass content of 4 percent, comprising a pathologicoanatomic headrest, having one stop for one side of the head, fixed to the surface of the headrest, on which the head of a corpse is located during a pathologicoanatomic autopsy, and a second stop with the ability to move and fix relative to the surface of the headrest until it stops at the other side of the head so that this side part of the head, also resting against the fixed above-mentioned stop and located on the surface of the headrest, also rests against the above-mentioned second stop with a force sufficient to fix the head located on the headrest, between the above-mentioned stops in the above-mentioned position, characterized by the presence of a rubber plate with a sulfur mass content of 4 percent, covering the surface of the above-mentioned stop fixed on the surface of the headrest, mounted on this surface, facing the above-mentioned stop, having the ability to move; sufficient to achieve the technical result provided by the above-mentioned invention—Fixing pathologicoanatomic headrest with a rubber pad with a sulfur mass content of 4 percent—characterized as corresponding in efficiency to the elasticity of the rubber plate with a mass content of 4 percent sulfur, covering the surface of the above-mentioned stop facing the above-mentioned stop, which can move, and which is fixed to the surface of the headrest, installed on this surface, preventing the slippage of the side part of the head pressed against this plate, which is a consequence of the technical effect objectively manifested when using the invention, associated with such a property as the elasticity of the rubber plate with a mass content of 4 percent sulfur, covering the surface of the above-mentioned stop facing the above-mentioned stop, which can move, and which is fixed to the surface of the headrest, installed on this surface: preventing the displacement of the fixed head of a corpse corresponding to the shape of the pressed side part of the head of a corpse of a certain, characteristic precisely of the elasticity of the rubber plate with a mass content of 4 percent sulfur, covering the surface of the above-mentioned stop facing the above-mentioned stop, which can move, fixed to the surface of the headrest, installed on this surface, caused by pressing the head of the corpse of the depression in the surface of the above-mentioned plate with a mass content of sulfur of 4 percent due to, as a consequence, the presence during the implementation of invention of this plate made of rubber with a mass content of sulfur of 4 percent, having an elasticity corresponding to this parameter, covering the surface of the above-mentioned stop facing the above-mentioned stop, which can move, fixed to the surface of the headrest, installed on this surface.

### BRIEF DESCRIPTION OF THE DRAWINGS

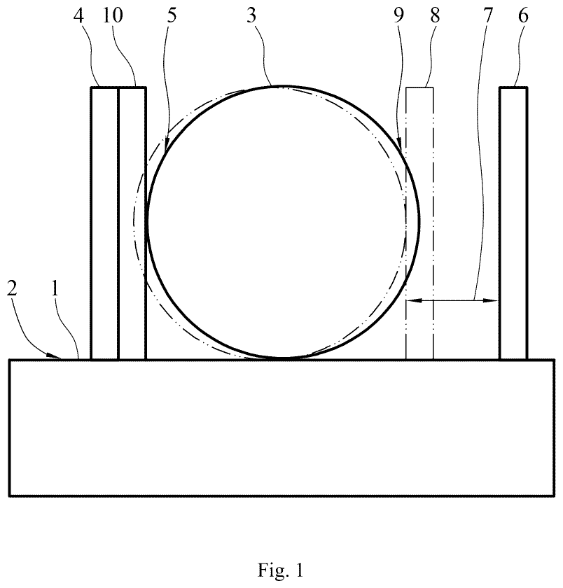

The presented FIG. 1 schematically depicts, as an example, the fixation of the head located on the Fixing pathologicoanatomic headrest with a rubber pad with a sulfur mass content of 4 percent.

### IMPLEMENTATION OF THE INVENTION

The invention will be described in detail below. However, it should be noted that the embodiment of the invention described below does not limit the invention. In addition, the constituent elements of the embodiment of the invention described below include elements that can be easily imagined by an ordinary person skilled in the relevant technical field, or elements that are essentially the same as elements that can be easily imagined by an ordinary person skilled in the relevant technical field. The invention can be implemented, for example, by manufacturing a fixing pathologicoanatomic headrest with a rubber pad with a sulfur mass content of 4 percent as a pathologicoanatomic headrest 1, having one stop 4 fixed to the surface 2 of the headrest 1, on which the head 3 of the corpse is located during a pathologicoanatomic autopsy, stop 4 with an installed plate 10 made of rubber with a sulfur mass content of 4 percent, covering the surface of the above-mentioned stop 4 facing the below listed stop 6, for one side part 5 of the head 3 installed on this surface and a second stop 6, with the possibility of moving 7 and fixing 8 relative to the surface 2 of the headrest 1 until it stops against the other side part 9 of the head 3 so that the side part 5 of the head 3 also, resting against the rubber plate with a sulfur mass content of 4 percent installed on the stop 4 and located on the surface 2 of the headrest 1, also rests against the stop 6 in position 8 with a force sufficient to fix the head 3 located on the headrest 1, between the stop 4, with the installed plate 10 made of rubber with a mass content of 4 percent sulfur, and the stop 6 in position 8, when there is a counteraction to the displacement of the fixed head 3 of the corpse due to a depression in the surface of the said rubber plate with a mass content of 4 percent sulfur facing the side part 5 of the head 3 of the corpse, which covers the surface of the said stop 4 facing the above-mentioned stop 6, which prevents the displacement of the fixed head 3 of the corpse, which depression corresponding to the shape of the pressed side part 5 of the head 3 of a certain, characteristic specifically for the elasticity of the above-mentioned rubber plate with a mass content of 4 percent sulfur, caused by the pressing of the head 3 of the corpse.

If necessary, the presentation of the above-mentioned embodiment of the claimed invention should be considered as a presentation of at least the best of the embodiments of the claimed invention proposed by the applicant.

Finally, it should also be noted that while the invention has been described with reference to an exemplary embodiment thereof, it should be understood that the invention is not limited to the exemplary embodiment described above, but covers any and all variations within the scope of the invention claim.

### INDUSTRIAL APPLICABILITY

Is obvious from the description and the nature of the invention.

1. A fixing pathologicoanatomic headrest with a rubber pad with a sulfur mass content of 4 percent, comprising a pathologicoanatomic headrest, having one stop for one side of the head, fixed to the surface of the headrest, on which the head of a corpse is located during a pathologicoanatomic autopsy, and a second stop with the ability to move and fix relative to the surface of the headrest until it stops at the other side of the head so that this side part of the head, also resting against the fixed above-mentioned stop and located on the surface of the headrest, also rests against the above-mentioned second stop with a force sufficient to fix the head located on the headrest, between the above-mentioned stops in the above-mentioned position, characterized by the presence of a rubber plate with a sulfur mass content of 4 percent, covering the surface of the above-mentioned stop fixed on the surface of the headrest, mounted on this surface, facing the above-mentioned stop, having the ability to move.
